(19) United States
(12) Patent Application Publication
(10) Pub. No.: US 2019/0105798 A1
(43) Pub. Date: Apr. 11, 2019

(54) PROCESS FOR SHAPING A REINFORCING OR STRUCTURAL MATERIAL FOR EXTRUDING/MOLDING OPERATIONS

(71) Applicant: Neauvotec, LLC, Auburn Hills, MI (US)

(72) Inventor: Miguel A. Linares, Bloomfield Hills, MI (US)

(73) Assignee: Neauvotec, LLC, Auburn Hills, MI (US)

(21) Appl. No.: 16/154,869

(22) Filed: Oct. 9, 2018

Related U.S. Application Data
(60) Provisional application No. 62/569,819, filed on Oct. 9, 2017.

(51) Int. Cl. B27J 1/00; B27K 9/00; E04C 3/12; E04C 3/29

(52) U.S. Cl. CPC B27J 1/003; B27K 9/002; E04C 3/29; E04C 3/122; B27K 9/005

(57) ABSTRACT

An assembly and related process for producing a structural article from a naturally occurring organic material and which includes the steps of conveying a plurality of lengths of the naturally occurring material through a coating operation in order to apply a non-activated adhesive, following which the coated materials are transferred to a succeeding forming operation for shaping and solidifying into a reformed cross sectional shape suitable for a structural application. Additional steps include the naturally occurring organic material further including any of, burlap, bamboo, bamboo strips, cane stalks, corn stalks, palm leaves, and reeds. A catalyst ingredient is provided for coating the materials, the catalyst optionally being incorporated into the adhesive.

### CROSS REFERENCE TO RELATED APPLICATIONS

The present application claims priority from U.S. Ser. No. 62/569,819, filed Oct. 9, 2017, the contents of which are incorporated by reference.

### FIELD OF THE INVENTION

The present invention relates generally to forming operations and processes for reshaping naturally occurring organic materials into elongated structural members. More specifically, the present invention teaches a process for shaping such a naturally occurring organic material (including any of bamboo, burlap, bamboo strips, cane stalks, corn stalks, palm leaves, reeds, etc.). The forming process for the elongated structural articles include the steps of applying adhesive to elongated conveyed strips of the materials, bundling the materials and successively passing through an extruding operation to reshape a cross sectional profile for a structural supporting application (e.g. “I” beam reshaping) along with catalyzing and hardening. An alternate variant teaches utilizing a lid enclosing mold in place of an extruder and for reshaping and solidifying (again through catalyzing the pre-applied adhesive such as to expand and harden to set the shape of the article according to the dimensions of the negative within the mold).

### BACKGROUND OF THE INVENTION

The prior art is documented with varying types of structural articles for use in construction and other applications. Traditional materials utilized include wood, steel or other composite materials.

WO2018059722A1, to Bluecher, teaches a catalytic and/or reactive unit, preferably in the form of a protective material with catalytic and/or reactive properties, particularly with the function of protecting from chemical and/or biological harmful and/or poisonous substances, preferably in the form of a textile protective filter material, as well as a method for producing same. The catalytic and/or reactive unit is particularly suitable for producing protective equipments and/or protective objects, and filter and filter materials of all types.

U.S. Pat. No. 7,939,156, to Slaven, teaches a composite concrete/bamboo structural members and process of manufacture therefor. The bamboo material includes layers formed of bamboo segments which have been dried and glue coated. The segments are substantially free of outer nodes and husk and inner membrane material prior to application of glue. The longitudinal axes of the segments in each layer are generally parallel to one another and are arranged in a mold to surround the surface of a cured concrete core. The layers of segments are heated, compressed and bonded together until the glue cures around the concrete core into a single integral structure. The concrete core is preferably reinforced with steel REBAR rods.

US20080023868A, to Slaven, teaches a bamboo building material and process of manufacture therefor. The material includes a plurality of layers each formed of bamboo segments which have been dried and glue coated. The segments are substantially free of outer nodes and husk and inner membrane material prior to application of glue. The longitudinal axes of the segments in each layer are generally parallel to one another, each layer having segments which may be generally parallel or oriented generally orthogonally with respect to the next adjacent layers thereto. The layers of segments being compressed and bonded together until the glue cures into a single integral structure and with improved physical properties.

### SUMMARY OF THE PRESENT INVENTION

The present invention discloses an assembly and related process for producing a structural article from a naturally occurring organic material and which includes the steps of conveying a plurality of lengths of the naturally occurring material through a coating operation in order to apply a non-activated adhesive, following which the coated materials are transferred to a succeeding forming operation for shaping and solidifying into a reformed cross sectional shape suitable for a structural application.

Additional steps include the naturally occurring organic material further including without limitation any of strips or pieces of burlap, bamboo, bamboo strips, cane stalks, corn stalks, palm leaves, and reeds. A catalyst ingredient is provided for coating the materials, the catalyst optionally being incorporated into the adhesive.

Other steps include trimming the materials to a desired length and bundling following coating and prior to reforming. The forming operation may also include the step of passing the coated material through an extruding operation to reshape a cross sectional profile for a structural supporting application along with catalyzing and hardening the ingredient as part of the non-activated adhesive. Additional steps include depositing the coated materials into a mold for reshaping and solidifying, through catalyzing the pre-applied adhesive such as to expand and harden to set the shape of the article according to the dimensions of the negative within the mold.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an assembly-like illustration of a line process for reshaping and forming an elongated and extruded structural article according to a first embodiment of the present invention;

FIG. 2 is s subset illustration of a first stage of the line process of FIG. 1 and which includes a plurality of elongated strands of the structural material being conveyed a curtain of a non-activated adhesive composition in order coat all of the surfaces of each length or strand, following which a given plurality of strands or lengths are bundled;

FIG. 3 is a further subset illustration of a second stage of the line process of FIG. 1 and in which the bundled lengths of pre-coated material is fed into a forming die or machine such as a length extending extrusion type heated die which concurrently reforms a cross sectional dimension of the material along with activating the adhesive according to catalysis in order to expand, set and cure the same into a rigid structural article exhibiting the cross section of the extruder die;

FIG. 4 is a subset illustration of an alternate second stage process to that depicted in FIG. 1 and by which the plurality of elongated and adhesive pre-coated strands of material are unbundled and deposited into the interior of a lid opening mold cavity; and

FIG. 5 is a succeeding illustration to FIG. 4 depicting a finished I beam style structural member which is removed from the mold cavity, this matching an interior profile of the mold and resulting from activation of the adhesive under any combination of heat, pressure or other catalysis promoting agent in order to expand and solidify the coating composition and substrate materials to the reformed shape.

### DETAILED DESCRIPTION OF THE PREFERRED EMBODIMENTS

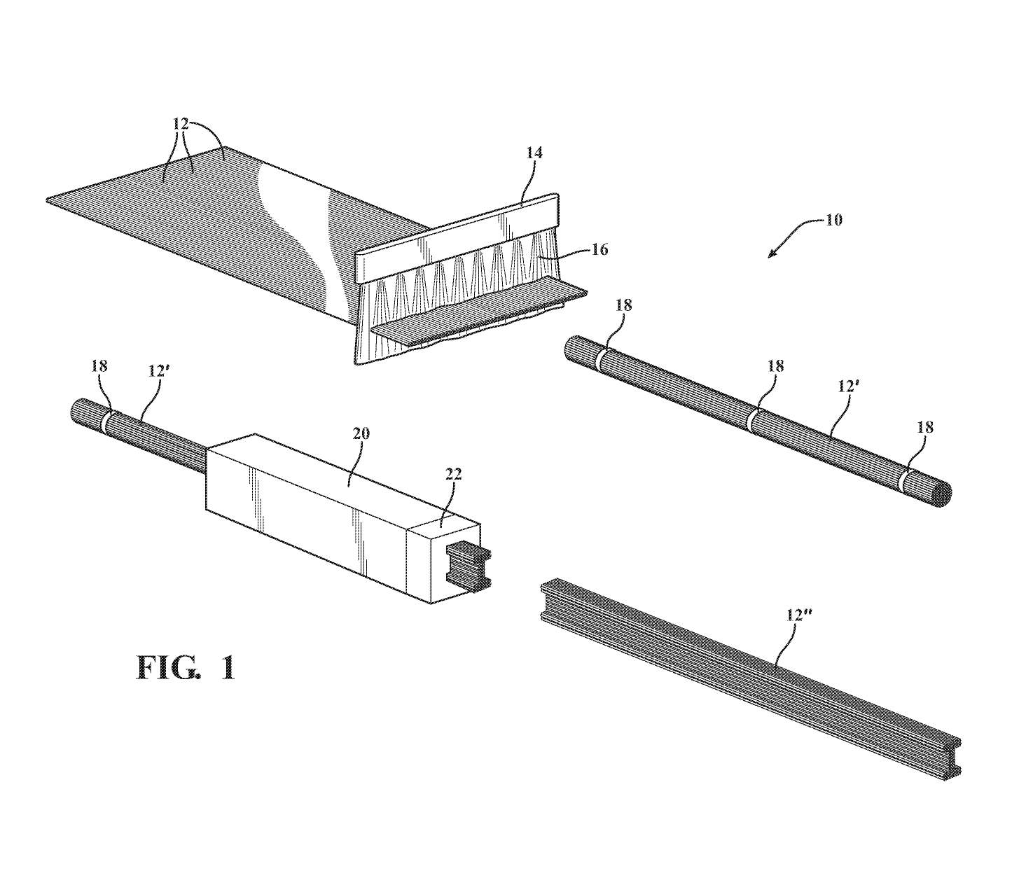

As will be described with reference to FIGS. 1-5, the present invention teaches a process for shaping, without limitation, such as any naturally occurring organic material and which can include a variety of different organic or naturally occurring materials not limited to any of bamboo, bamboo strips, cane stalks, corn stalks, palm leaves, reeds, etc., in order to create a structurally supporting member which substantially exhibits the properties of steel, hardwood or the like. As will also be disclosed, a non-activated adhesive is coated or otherwise applied to elongated conveyed strips of the materials, following which these are bundled and successively passed through an extruding operation to reshape a cross sectional profile for reforming into a shape suitable for a structural supporting application (e.g. “I” beam reshaping), this along with catalyzing and hardening the member by activating or catalyzing the adhesive and which may include any suitable foam expanding composition in order to achieve its completed cross sectional profile.

An alternate variant teaches utilizing a lid enclosing mold in place of an extruder and for reshaping and solidifying (again through catalyzing the pre-applied adhesive such as to expand and harden to set the shape of the article according to the dimensions of the negative within the mold). As with the extruding operation, any suitable expanding agent or catalyst can be integrated into the previously coated adhesive to achieve the desired expansion properties in combination with the substrate supporting aspects of the underlying naturally occurring material.

Referring initially to FIG. 1, an assembly-like illustration is generally shown at 10 of a line process for reshaping and forming an elongated and extruded structural article according to a first embodiment of the present invention and which includes a plurality of lengths of a selected substrate or core material, such in the illustrated instance being lengths of bamboo 12 which are laid or otherwise arranged in side by side extending fashion. As described, the natural occurring materials can include those having any combination of stiff, rigid or fibrous physical properties and such as which are exhibited by certain types of wood (again bamboo), as well as any of burlap strips or pieces, bamboo strips, cane stalks, corn stalks, palm leaves, reeds or the like.

Any collection of guides, conveyors or the like (not shown) are provided for conveying the bamboo 12 through a coating process for applying such as a non-activated adhesive coating. In the illustrated embodiment, any of a manifold or overhead feed supply, see at 14, is provided for communicating a steady stream of the adhesive, see at 16, which can be applied as a continuous flow or curtain for intersecting the lengths of bamboo 12 or other elongated insert material as the same is drawn through the adhesive curtain. It is further envisioned that continuous and even adhesive application can be facilitated by any plurality of vertical or angularly arrayed brush bristles, strands or the like which assist in evenly distributing the adhesive across the curtain at the point of intersection with the drawn through bamboo lengths 12. The non-activated adhesive may or may not include a separate catalyst for providing foam expansion of a coating or binding material surrounding the plurality of naturally occurring members.

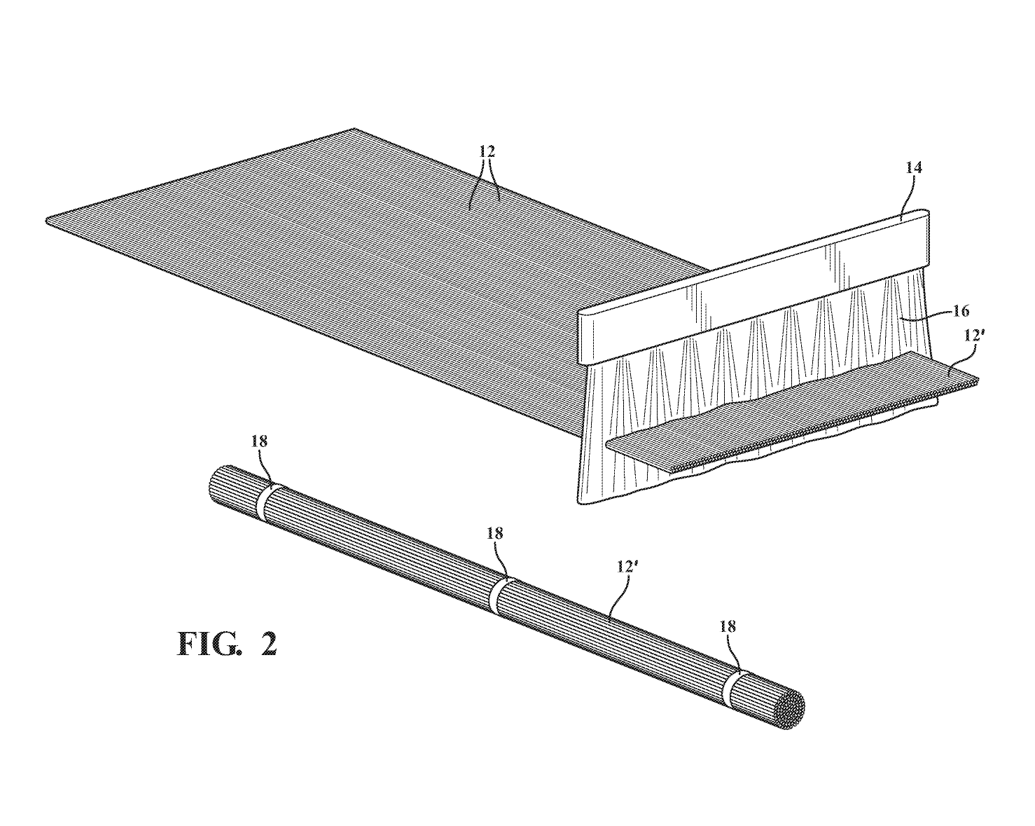

FIG. 2 is a subset illustration of a first stage of the line process of FIG. 1 and which again includes the plurality of elongated strands 12 of the structural material (again such as bamboo) being conveyed through the curtain of non-activated adhesive composition in order coat all of the surfaces of each length or strand, further at 12′, following which a given plurality of strands or lengths are bundled as further depicted by ties or straps 18 for processing and/or transporting. The non-activated adhesive coating can include any resin or polymer based ingredient, foaming agent or catalyst such as will cause the coating to expand and solidify upon the application of heat, pressure or other triggering condition.

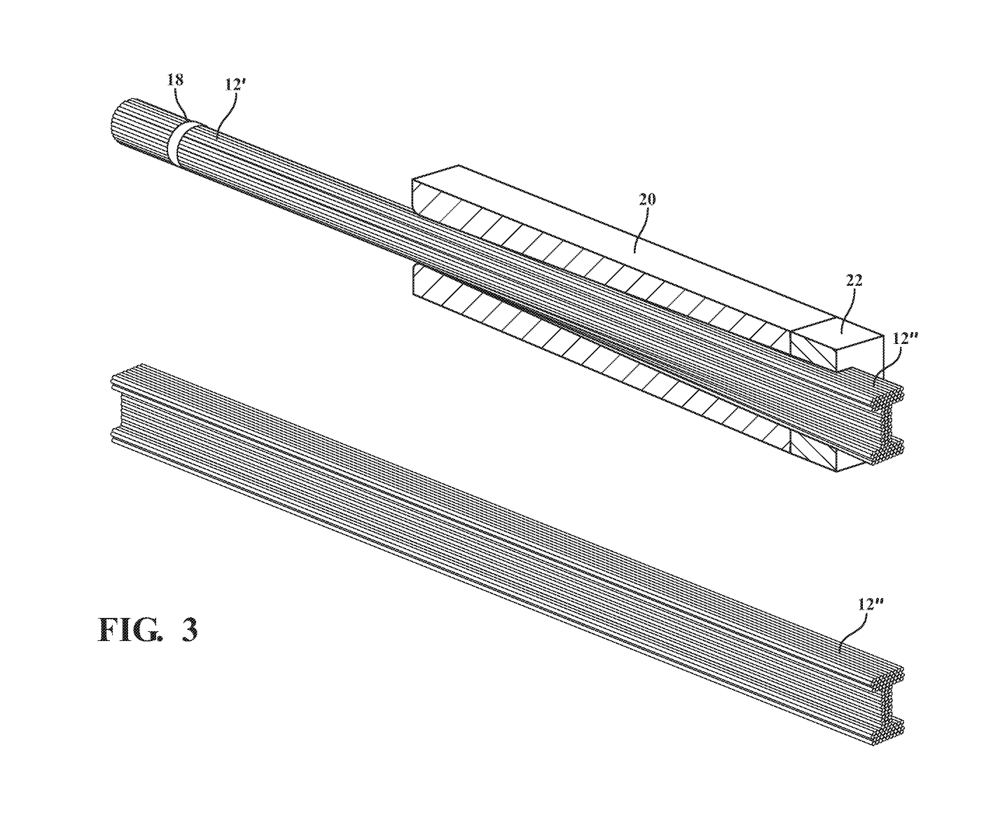

FIG. 3 is a further subset illustration of a second stage of the line process of FIG. 1 and in which the bundled lengths of pre-coated material 12′ is fed into a forming die, such including a first shaping section 20 and a second interconnecting heating section 22 such as a length extending catalyzing or extruding type electrical resistance heated die which concurrently reforms a cross sectional dimension of the material along with activating the adhesive according to catalysis in order to expand, set and cure the same into a rigid structural article 12″ exhibiting the cross section of the extruder die (in this case a conventional I beam shape). As shown, and once the structural material (still substantially at position 12′) reaches the heating section 22, the catalyst integrated into substrate material, such again including an additive or agent to the non-activated adhesive or another input, is caused to react through the input of any of light, stem, liquid or any other catalyzing input, such as which can be incorporated into any envisioned reconfiguration of the heating section 22, in order to cause the coating surrounding the reformed cross sectional material to expand, solidify and cure into a hardened form according to desired cross sectional dimensions and profile.

In this manner, a hardened reformed (such as “I” beam shaped) article is produced at 12″ and which can then be sectioned according to desired lengths for transport and subsequent use. Beyond providing a primary objective of heating/expanding/curing the adhesive pre-applied to the bunched material, it is further envisioned and understood that the heating section 22 can also include extrusion capabilities for applying any type of flowable binder material (such as through the provision of a cross head die).

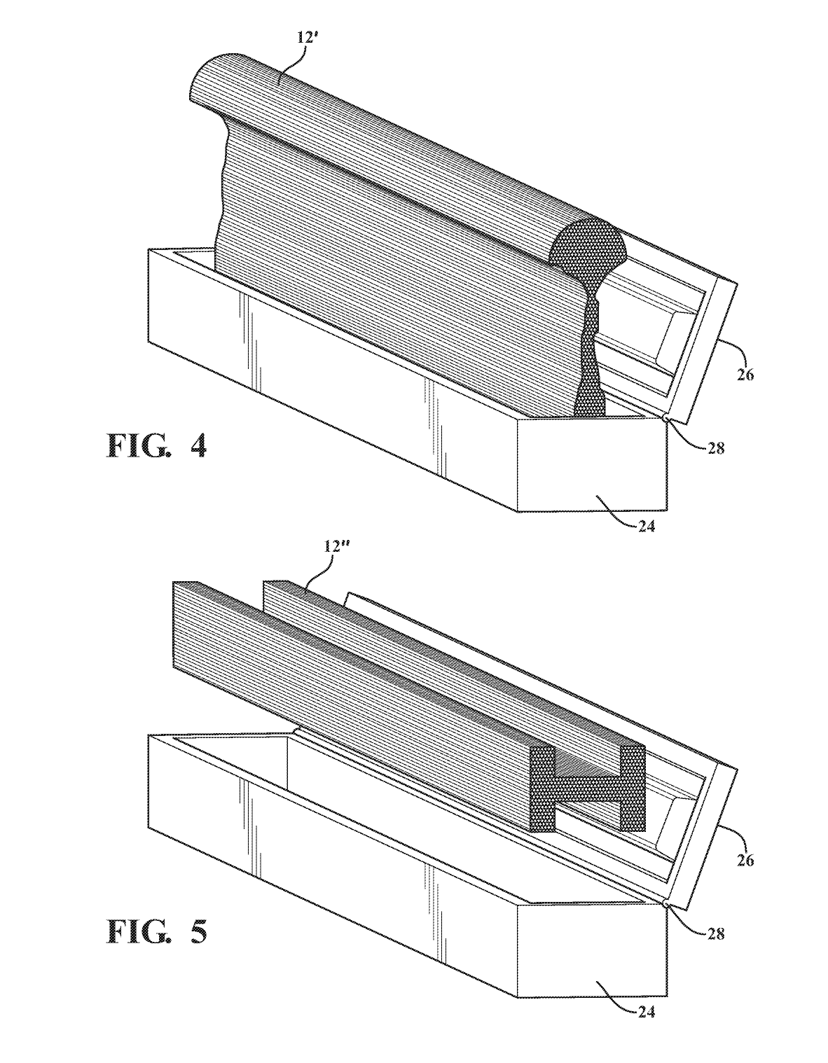

FIG. 4 is a subset illustration of an alternate second stage process to that depicted in FIG. 1 and by which the plurality of elongated and adhesive pre-coated strands of material 12′ are unbundled and deposited into the interior of a lid opening mold cavity, this generally referenced by main body 24 having interconnected sides and a bottom and which, in combination with a lid 26 hingedly connected at 28, defines an interior cavity which, upon closing the lid 26, defines a mating negative configuration of the part to be produced, such as again being an “I” beam cross sectional configuration. The mold interior defining surfaces can include pattern or configuration for creating any desired cross sectional shaped structural article and, given the material composition of the adhesive coating or any associated catalysts, can also include any suitable release surface for facilitating formation and removal of the completed article.

As with the preceding variant, the bundles of pre-coated materials (bamboo) 12′ are initially cut to a predetermined length, following which the bundles are opened (through removal of the straps) and packed into the open mold interior, such as according to a desired aggregating volume of members which will correspond to a desired cured and expanded end product. Upon closing of the mold, it is heated through any suitable electrical or other thermo heating operation (or a suitable catalyst applied which can again include any of light, stem, liquid or the like) in order to provide both curing and, optionally, some degree of concurrent expansion/hardening of the material in order to form the final product according to desired cross sectional and length dimensions.

As finally shown in FIG. 5, which is a succeeding illustration to FIG. 4, the mold is reopened upon completion of the cycle to reveal a completed I beam style structural member, again at 12″ and which, upon being removed from the mold cavity, matches an interior profile of the mold resulting from activation of the adhesive under any combination of heat, pressure or other catalysis promoting agent in order to expand and solidify the coating composition and substrate materials to the reformed shape. Although not shown, either of the continuous extrusion forming operation of FIG. 3 or the closed mold operation of FIGS. 4-5 can include any suitably configured heating profile, such including thermocouples for modulating the temperature profile of either the heated section 22 of the extruder or the coils (not shown) associated with the interior of the closed mold (such as which can further include heating elements integrated into both the lid and base.

In this manner, the structural article thereby created inherits all of the underlying properties of the naturally occurring material (such as the strength of bamboo or the other chosen organic base material) this combined with the binding and expansion properties of adhesive coating and the associated expansion/curing catalyst component, whether part of the original coating composition or separately applied.

Having described my invention, other and additional preferred embodiments will become apparent to those skilled in the art to which it pertains, and without deviating from the scope of the appended claims:

I claim:

1. A process for producing a structural article from a naturally occurring organic material, comprising the steps of:
conveying a plurality of lengths of the naturally occurring material through a coating operation in order to apply a non-activated adhesive; and
transferring the coated materials to a succeeding forming operation for shaping and solidifying into a reformed cross sectional shape suitable for a structural application.

2. The invention of claim 1, the naturally occurring organic material further including any of bamboo, bamboo strips, burlap, cane stalks, corn stalks, palm leaves, reeds, etc.

3. The invention of claim 1, further comprising a catalyst ingredient coating the materials, the catalyst optionally being incorporated into the adhesive.

4. The invention of claim 1, further comprising the step of trimming said materials to a desired length and bundling following coating and prior to reforming.

5. The invention of claim 3, said forming operation further comprising the step of passing said coated material through an extruding operation to reshape a cross sectional profile for a structural supporting application along with catalyzing and hardening the ingredient as part of the non-activated adhesive.

6. The invention of claim 3, said forming operation further comprising the step of depositing the coated materials into a mold for reshaping and solidifying, through catalyzing the pre-applied adhesive such as to expand and harden to set the shape of the article according to the dimensions of the negative within the mold.

7. An assembly for producing a structural article from a naturally occurring organic material, comprising:
a conveyor for transporting a plurality of lengths of the naturally occurring material beneath or through a manifold for applying to the material a coating of a non-activated adhesive and binder;
a die forming machine through which a bunched arrangement of the coated materials are passed in order to reform a cross sectional profile of the bunched material; and
an adhesive/binder activating component in communication with the die forming machine for shaping and solidifying the material into a reformed and finished structural article having a cross sectional shape suitable for a structural application.

8. The assembly as described in claim 7, the naturally occurring organic material further including any of bamboo, bamboo strips, burlap, cane stalks, corn stalks, palm leaves, reeds, etc.

9. The assembly of claim 7, the non-activated adhesive and binder further comprising a catalyst ingredient coating the materials, the catalyst optionally being incorporated into the adhesive.

10. The assembly of claim 7, further comprising a trimmer for sectioning the reformed and finished structural article to desired lengths.

11. A die assembly for forming a bundle of a loose organic material into a structural article, comprising:
a mold having a base and a hingedly supported top, said base and top collectively defining an interior which is a negative of a structural part to be produced;
upon the loose organic material being pre-cut and placed within said base, an adhesive and binder being applied to the organic material concurrent with said top being closed; and
a catalyst activating the adhesive and binder to expand and solidify the loose material into a reformed and finished structural article having a cross sectional shape suitable for a structural application.

12. The die assembly of claim 11, said negative interior established between said base and top further comprising an I beam profile.
